(19) United States
(12) Patent Application Publication
(10) Pub. No.: US 2021/0121994 A1
(43) Pub. Date: Apr. 29, 2021

(54) DRILL PRESS WITH MODULAR DRILL PRESS TABLE

(71) Applicant: JPW Industries Inc., La Vergne, TN (US)

(72) Inventors: Micah Coleman, Nashville, TN (US); Tobias Bridges, Holly Springs, NC (US); Charles Weber, Onalaska, WI (US); Thomas Balko, La Crosse, WI (US)

(21) Appl. No.: 17/080,394

(22) Filed: Oct. 26, 2020

Related U.S. Application Data
(60) Provisional application No. 62/925,396, filed on Oct. 24, 2019.

(51) Int. Cl. B23Q 1/03; B23B 39/00; B23Q 11/00

(52) U.S. Cl. CPC B23Q 1/03; B23Q 11/0042; B23B 39/00

(57) ABSTRACT

A drill press is disclosed including a drill press column. A drill press spindle assembly can be mounted to the drill press column. A drill press table can include a table frame secured to the drill press column and a table insert removably received in the table frame. The table frame can be positioned on the support column beneath the drill press spindle assembly, and the table insert can be positionable under the drill press spindle assembly when the table insert is received in the table frame. A work piece can be supported by the drill press table insert and the drill press spindle assembly can be operable to engage the work piece supported by the drill press table insert. Different table inserts can be interchangeable to provide different functionalities for the drill press as desired without having to replace the entire drill press table on the column.

### CROSS-REFERENCES TO RELATED APPLICATIONS

This application is a non-provisional of U.S. patent application Ser. No. 62/925,396 filed Oct. 24, 2019 entitled DRILL PRESS WITH MODULAR DRILL PRESS TABLE, which is hereby incorporated by reference in its entirety.

A portion of the disclosure of this patent document contains material that is subject to copyright protection. The copyright owner has no objection to the reproduction of the patent document or the patent disclosure, as it appears in the U.S. Patent and Trademark Office patent file or records, but otherwise reserves all copyright rights whatsoever.

### STATEMENT REGARDING FEDERALLY SPONSORED RESEARCH OR DEVELOPMENT

Not Applicable

### REFERENCE TO SEQUENCE LISTING OR COMPUTER PROGRAM LISTING APPENDIX

Not Applicable

### BACKGROUND OF THE INVENTION

The present disclosure relates generally to drill presses, drill press tables, and drill press attachments or ancillary components.

More particularly, the present disclosure relates to the use of drill presses to perform drilling processes on work pieces of different types of materials. In conventional drill presses, when working on different types of materials, such as wood, metal, or plastics, it can be desirable to engage the work piece with a drill bit or other tooling of a drill press at different operating speeds depending on the type of material being worked on to help reduce damage to the work piece and wear on the drill press. Additionally, different drill press table designs have been developed for use when drilling or performing other manufacturing processes on work pieces of different material types, for instance those of metal or wood. Different drill press tables have also been developed to accommodate and retain certain types of objects or accommodate and retain work pieces in different orientations depending on the desired hole to be drilled, for instance via desired ancillary components such as clamps or retention blocks that can be secured to the drill press table.

In conventional drill press applications, a single drill press table is connected to a column of a drill press via a collar clamped around the drill press column. If a user desires to use a different drill press table design, they would have to purchase an entirely new drill press table, dismantle the drill press head or spindle assembly from the drill press column, switch out the drill press tables, and remount the drill press head, which is cumbersome and undesirable.

What is needed then are improvements in drill presses and drill press table design.

### BRIEF SUMMARY

This Brief Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

One aspect of the present disclosure is a drill press including a drill press column. A drill press spindle assembly can be mounted to the drill press column. A drill press table can include a table frame secured to the drill press column and a table insert removably received in the table frame. The table frame can be positioned on the support column beneath the drill press spindle assembly, and the table insert can be positionable under the drill press spindle assembly when the table insert is received in the table frame. A work piece can be supported by the drill press table insert and the drill press spindle assembly can be operable to engage the work piece supported by the drill press table insert.

Another aspect of the present disclosure is a drill press table for a drill press having a drill press column and a drill press spindle assembly mounted to the drill press column, the drill press table including a column connection assembly securable to the drill press column. A table frame can be connected to the column connection assembly, the table frame positionable beneath the drill press spindle assembly when the column connection assembly is secured to the drill press column, the table frame including a receptacle. A table insert can be provided, and at least a portion of the table insert can be removably receivable in the receptacle of the drill press table frame. Such drill press tables and varying table inserts can be sold separately from associated drill presses to equip pre-existing drill presses with modular drill press tables. In some embodiments, the table frame can include two lateral frame members, at least one cross support extending between the two lateral frame members, and a recessed area can be formed between the two lateral frame members and above the at least one cross support to form the receptacle in the table frame in which the table insert can be received.

Different drill press table inserts can be provided which can alternatingly be received in the drill press table frame such that the table inserts can be modular and interchangeable on the drill press table frame, without the drill press table frame, and thus the entire drill press table, being removed from the drill press support column. In some embodiments, the drill press head spindle assembly can include a motor assembly that can be configured to selectively alternate the drill press head spindle assembly between two or more variable speeds.

Numerous other objects, advantages and features of the present disclosure will be readily apparent to those of skill in the art upon a review of the following drawings and description of a preferred embodiment.

### BRIEF DESCRIPTION OF THE DRAWINGS

FIG. 1 is a perspective view of an embodiment of a drill press of the present disclosure showing a table frame of a drill press table secured to a drill press column with a table insert of the drill press table removed.

FIG. 2 is a perspective view of the drill press of FIG. 1 with one embodiment of a table insert received on the table frame to support a work piece.

FIG. 3 is an exploded view of the drill press table of FIG. 2.

FIG. 4 is a perspective view of another embodiment of a table frame of a drill press table of the present disclosure.

FIG. 5 is a perspective view another embodiment of a table insert having a retention blocks or stops positioned on the table frame of FIG. 4.

FIG. 6 is a perspective view of another embodiment of a table frame for a drill press table of the present disclosure wherein the table frame includes lateral extension members.

FIG. 7 is a perspective view of another embodiment of a table frame for a drill press table of the present disclosure including drawers and shelves for storing and holding tools or other objects.

FIG. 8 is a perspective view of another embodiment of a drill press table frame showing a plurality of vises positioned and secured in accessory slots defined on the table frame of the drill press table.

FIG. 9 is a perspective view of another embodiment of a drill press table of the present disclosure wherein a woodworking table insert when received on the table frame extends laterally beyond the table frame.

FIG. 10 is a perspective view of another embodiment of a drill press table of the present disclosure including a table insert that can be rotatably disposed on the table frame.

FIG. 11 is a perspective view of another embodiment of a drill press table of the present disclosure including a vise rail and vise removably secured to the table frame.

FIGS. 12-14 show various embodiments of drill press tables of the present disclosure having table inserts with various accessory slots defined in the table insert.

FIG. 15 is a perspective view of another embodiment of a drill press of the present disclosure including a drill press table with a table insert adapted for use with a sanding drum for the drill press.

FIG. 16 is a top perspective view of the drill press of FIG. 15 with a top table insert portion removed to show the lower downdraft table insert portion of the table insert.

FIG. 17 is an exploded view of the drill press table of FIG. 15.

FIG. 18 is a perspective view of the drill press of FIG. 15 during a sanding operation.

FIG. 19 is a perspective view of another embodiment of a drill press with a modular drill press table insert suitable for use with a sanding attachment, the table insert allowing for movement of the sanding drum relative to the table insert.

FIG. 20 is a detailed view of the attachment of a sanding drum to the drill press spindle assembly.

FIG. 21 is a detailed perspective view of the sanding drum rotatably connected to an attachment support structure.

FIG. 22 is a detailed perspective view of the drill press of FIG. 19 showing the sanding drum being moved relative to the table insert by moving the spindle assembly.

FIG. 23 is a detailed perspective view of the drill press of FIG. 19 showing the table insert being moved relative to the sanding drum by moving the drill press table on the drill press column.

FIG. 24 is a side view of another embodiment of a drill press table insert for use with a sanding attachment including a motorized adjustment mechanism for adjusting the position of the sanding attachment relative to the table insert.

FIG. 25 is a perspective view of the drill press of FIG. 19 with a dust collection or downdraft assembly coupled to the table insert.

### DETAILED DESCRIPTION

While the making and using of various embodiments of the present invention are discussed in detail below, it should be appreciated that the present invention provides many applicable inventive concepts that are embodied in a wide variety of specific contexts. The specific embodiments discussed herein are merely illustrative of specific ways to make and use the invention and do not delimit the scope of the invention. Those of ordinary skill in the art will recognize numerous equivalents to the specific apparatus and methods described herein. Such equivalents are considered to be within the scope of this invention and are covered by the claims.

In the drawings, not all reference numbers are included in each drawing, for the sake of clarity. In addition, positional terms such as “upper,” “lower,” “side,” “top,” “bottom,” etc. refer to the apparatus when in the orientation shown in the drawing. A person of skill in the art will recognize that the apparatus can assume different orientations when in use.

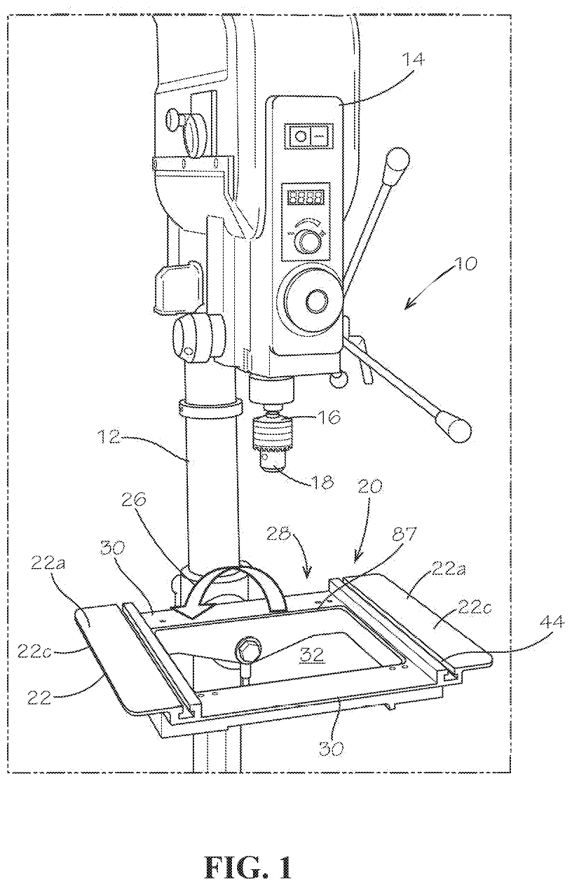

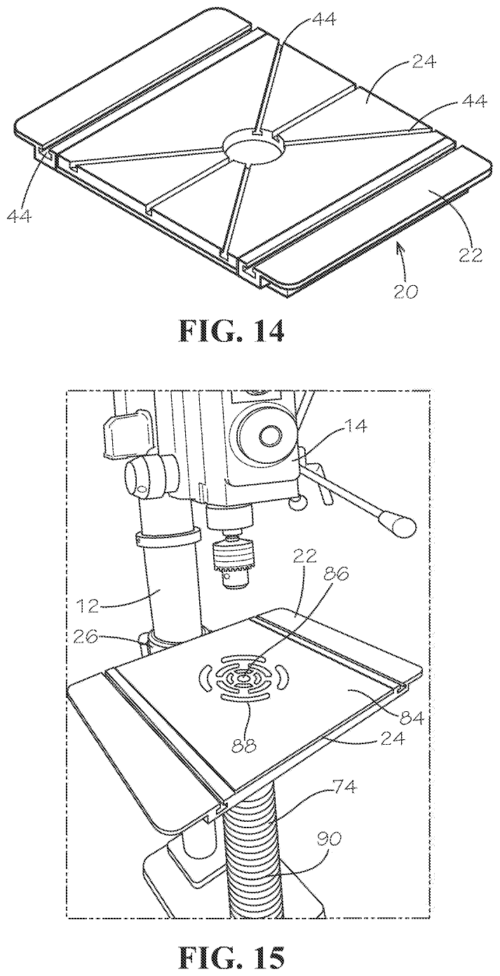

As shown in FIGS. 1-15, one aspect of the present disclosure is a drill press 10 including a drill press column 12. A drill press spindle assembly 14 can be mounted to the drill press column 12. The drill press spindle assembly 14 can include a rotating spindle 16 and chuck 18 for holding a drill bit or other working element 27 to be driven by the spindle 16.

A drill press table 20 can include a drill press table frame 22 mounted to the drill press column 12 and a drill press table insert 24 removably received on the drill press table frame 22. The drill press table frame 22 can include a column connection assembly 26 such as a collar that can be received about and clamped to the drill press column 12. The drill press table frame 22 can be positioned on the drill press column 12 beneath the drill press spindle assembly 14, and the drill press table insert 24 can be positionable under the spindle 16 of the drill press spindle assembly 14 when the drill press table insert 24 is received in the drill press table frame 22. A work piece 25 can be supported by the drill press table insert 24, and the table frame 22 in some applications, and the drill press spindle assembly 14 can be operable to engage the working element 27, such as a drill bit, driven by the spindle 16 with the work piece 25 supported by the drill press table insert 24.

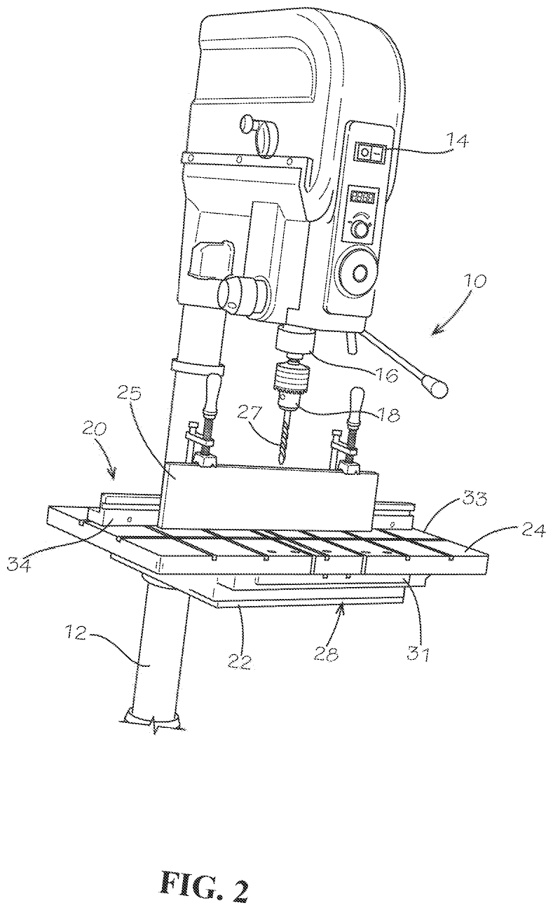

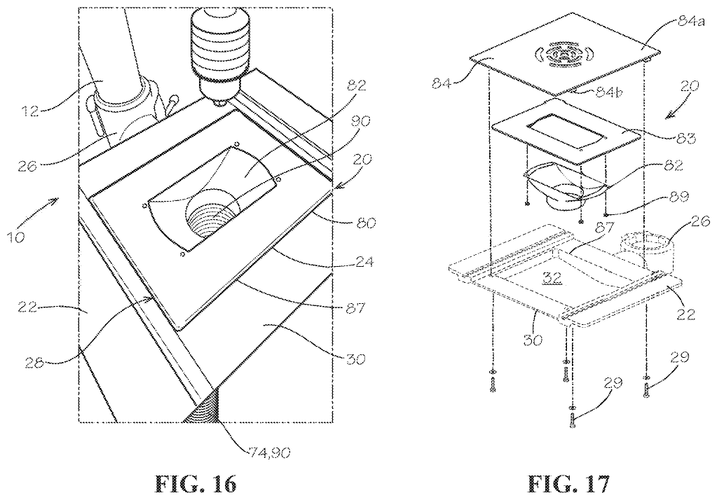

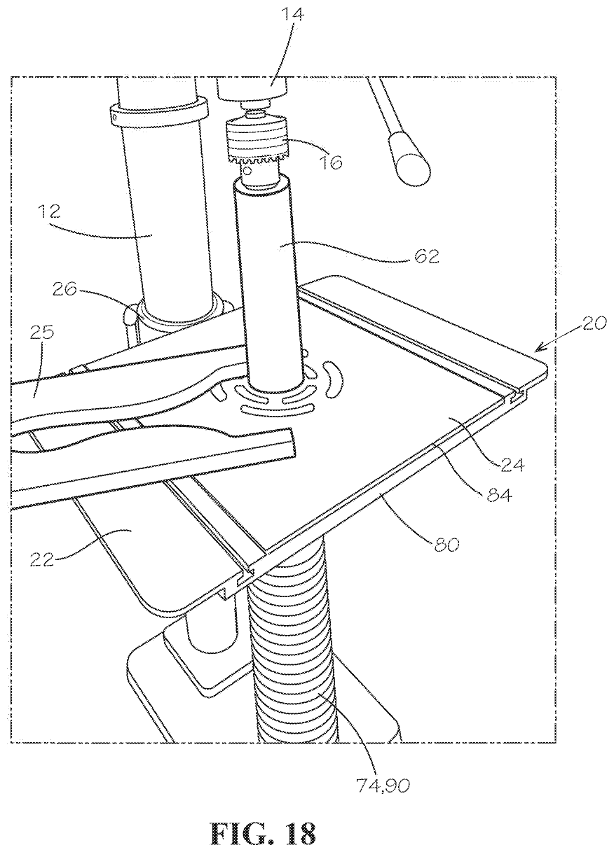

Different drill press table inserts 24 can be provided which can be alternatingly received in the drill press table frame 22 such that the table inserts 24 can be modular and interchangeable on the drill press frame 22, without the drill press frame 22, and thus the entire drill press table 20, having to be removed from the drill press column 12. Various exemplary embodiments for the drill press table insert 24 can be seen in FIGS. 2-19, which can be utilized for work pieces of different material types (wood, metal, plastic, etc.), to retain work pieces in varying positions (in some applications utilizing various tools such as clamps, blocks, stops, vises, etc. which can be secured to the table insert 24 or the table frame 22), or to provide different types of manufacturing or processing methods including drilling, sanding, grinding, polishing, etc. While a few exemplary embodiments for table inserts are shown in this disclosure, the possibilities for table insert structures are numerous and can be specifically tailored for a certain drill press operation or a particular work piece or work piece hole shape or desired orientation.

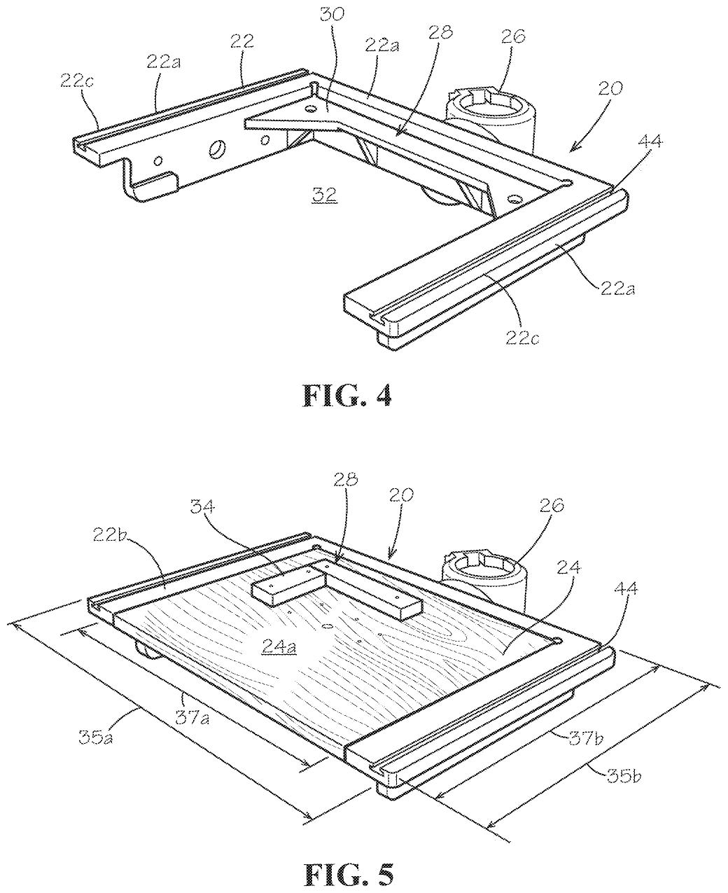

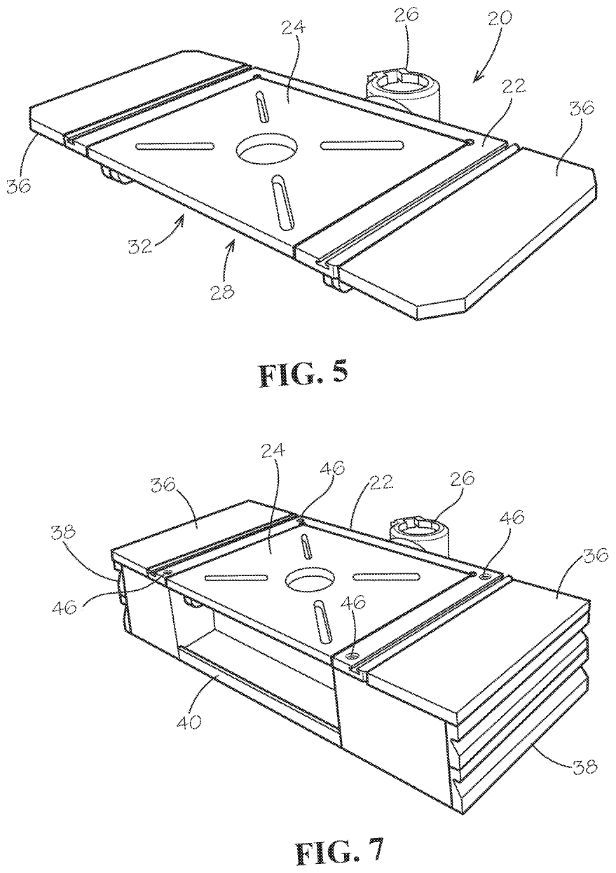

In some embodiments, as shown In FIGS. 1-5, the drill press table frame 22 can include perimetric frame members 22a that can form a receptacle, recessed area, or seat 28 into which at least a portion of the drill press table insert 24 can be received. In one embodiment, the drill press table frame 22 can have a substantially U or C shape that can form a rectangular receptacle or recessed area 28 into which a rectangular shaped drill press table insert 24 can be received, as shown in FIGS. 4-5. In other embodiments, the table frame 22 and or receptacle or seat 28 therein and the table insert 24 can have any suitable shape, including but not limited to triangular, round, circular, or trapezoidal shapes.

In some embodiments, one or more cross supports 30 can span the receptacle or recessed area 28 of the table frame 22. The table insert 24 can be positioned on and supported by the one or more cross supports 30 to retain the table insert 24 in the receptacle or recessed area 28 of the table frame 22. In some embodiments, the table frame 22 can include two lateral frame members 22c, at least one cross support 30 extending between the two lateral frame members 22c, and a recessed area 28 formed between the two lateral frame members 22c and above the at least one cross support 30. In some embodiments, as shown in FIGS. 4-5, a single cross support 30 can span across the receptacle or seat 28, and a table insert 24 can be secured to the single cross support 30 and cantilevered in the receptacle 28. In other embodiments, as shown in FIG. 1, cross supports 30 can be provided at a front and back of the table frame 22 between perimetrical frame members 22a, which can help prevent downward twisting or bending of the table insert 24 during a drilling operation. In still other embodiments, the inner perimeter of the table frame 22 can be inclined upward and away from the receptacle 28, and the perimeter of the table insert 24 can have a corresponding incline such that when the table insert 24 is positioned in the receptacle 28, the corresponding inclined surfaces of the table frame 22 and the table insert 24 can engage one another to retain the table insert 24 in the receptacle 28 and provide support around at least a portion of the perimeter of the table insert 24.

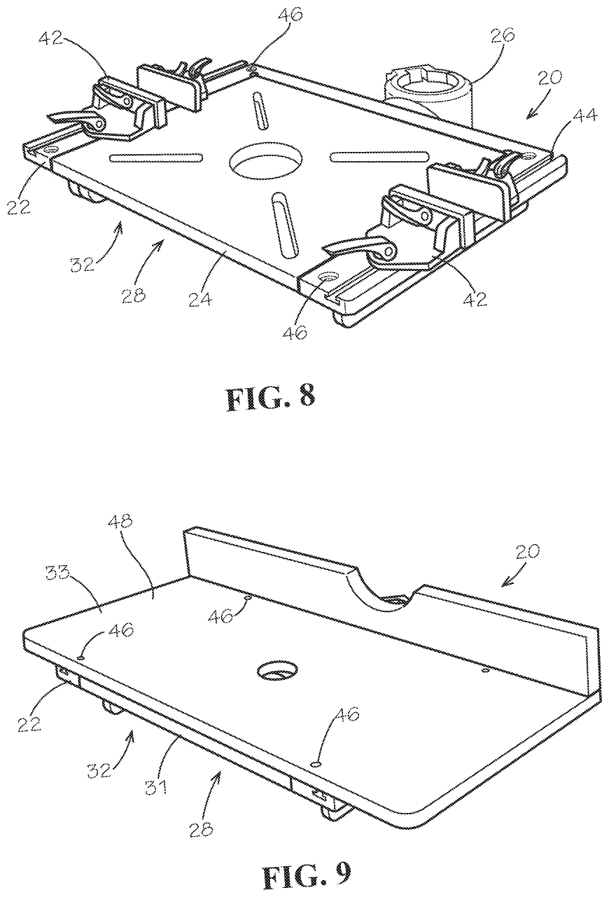

In some embodiments, when the table insert 24 is received in the table frame 24, the top surface 24a of the table insert 24 and a top surface 22b of the table frame 22 can be flush or have a flush orientation with one another. As such, a smooth transition between the table frame 22 and the table insert 24 can be achieved which can help optimize the available space on the table 20 for supporting a work piece. In other embodiments, the top of the table insert 24 can include a lower portion 31 and an upper portion 33, the lower portion 31 received in the table frame 22, and the upper portion 33 positioned above the table frame 22 when the lower portion 31 is received in the table frame 22, as shown in FIGS. 2 and 9. In some embodiments, the upper portion 33 of the table insert 24 can extend laterally beyond the table frame 22 to provide additional surface area for supporting a work piece as needed.

As shown in FIG. 5, the table frame 22 can have a table frame width 35a as measured from a front of the table frame 22. The table insert 24 can have a table insert width 37a as measured from a front of the table insert 24. In some embodiments, the table insert width 37a can be at least half of the table frame width 35a. In some embodiments, the table insert width 37a can be at least 60, 65, 75, 75, 80, 85, 90, or 95 percent as large as the table frame width 35a. Similarly, the table frame 22 can have a table frame depth 35b as measured from a side of the table frame 22. The table insert 24 can have a table insert depth 37b as measured from a side of the table insert 24. In some embodiments, the table insert depth 37b can be at least half of the table frame depth 35b. In some embodiments, the table insert width 37a can be at least 60, 65, 75, 75, 80, 85, 90, or 95 percent as large as the table frame width 35a. Having a table insert 24 with a width and depth at least half that of the table frame width and depth can allow a larger portion of the overall drill press table 20 to be modular or interchangeable which can allow for a greater variety of table insert designs and configurations to be interchanged on the table frame 22.

In some embodiments, the table frame 22 can include one or more magnets and the table insert 24 can be made of a ferromagnetic material, such that the table insert 24 can be magnetically engaged with the magnets on the table frame 22 when the table insert 24 is positioned on the table frame 22. In other embodiments, the table frame 22 can be made of a ferromagnetic material and the table insert 24 can include one or more magnets such that magnets on the table insert 24 can be magnetically engaged with the table frame 22 when the table insert 24 is received in or on the table frame 22. Magnetic attachment of the table insert 24 on the table frame 24

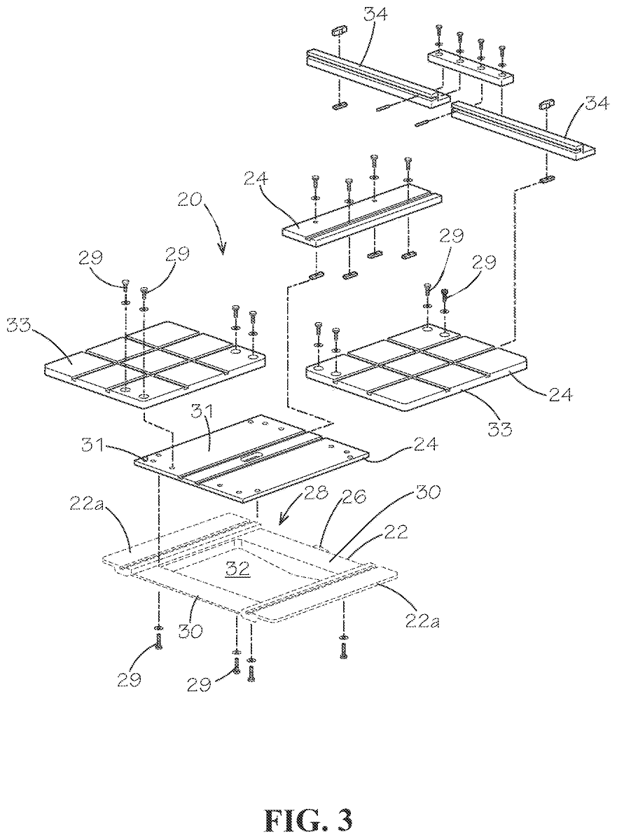

In some embodiments, as shown in FIG. 3, the table frame 22 and the table insert 24 can be removably connected to one another via a plurality of removable fasteners 29. The fasteners 29 can include bolt and nut assemblies, bolt and threaded bore assemblies, or any other suitable mechanism for removably securing the table insert 24 to either the perimetrical frame members 22a or the cross supports 30 of the table frame 22. In some embodiments, the table insert 24 can have a lower receptacle portion 31 that is received in the receptacle 28 and one or more upper table top portions 33 that can extend above the table frame 22. In some embodiments, the table frame 22 (cross supports 30), the lower receptacle portion 31, and the one or more upper table top portion 33 can each have fastener holes defined therein such that the receptacle portion 31 can be received in the receptacle 28, the one or more table top portions 33 can be positioned on top of the receptacle portion 31, and the fasteners 19 can be inserted through corresponding holes in the table frame 22, the receptacle portion 31 and the one or more table top portions 33 to removably secure the table frame 22, the receptacle portion 31 and the one or more table top portions 33 together. Having table insert portions 31 and 33 that can be fastened together can help reduce the shipping size of table inserts 24 that are larger when assembled. In other embodiments, as shown in FIG. 9, the receptacle portion 31 and the table top portion 33 can be integrally formed together as a single piece and removably secured or connected to the table frame 22.

Referring again to FIGS. 1 and 4, the table frame 22 in some embodiments can include an aperture or hole 32 accessible from a bottom of the receptacle 28 in the table frame 22. The aperture or hole 32 can allow a user to access the table insert 24 from below the table frame 22 to push the table insert 24 out of the receptacle 28 in the table frame 22 to facilitate removal and changing of the table insert 24, when desired, with another table insert. In some embodiments, the aperture or access 32 can be formed between the cross supports 30 spanning the receptacle or recessed area 28. In other embodiments, the front of the table frame 22 adjacent the receptacle 28 can be open such that table insert 24 can slide in and out of the receptacle 28 in the table frame 22.

As shown in FIGS. 3 and 5, in some embodiments, the table insert 24 can include one or more stops 34 secured to the table insert 24 to aid in positioning and/or retaining a work piece in a desired position or orientation on the table insert 24.

As shown in FIGS. 6 and 7, in some embodiments, the table frame 22 can have laterally extending table extensions 36 that can be used to help further support longer work pieces such as wooden or metal boards. A user can also place tools, measuring devices, etc. on the table extensions 36 during use of the drill press so they can be readily accessible. In some embodiments, the table extensions 36 can be made of different materials than the remainder of the table frame 22. For instance, in some embodiments the table extensions 36 can include a non-slip coating which can help prevent tools and other items place on the table extensions 36 from sliding off the table 20. In other embodiments, perimetrical frame members 22a of the table frames 22 can have a wider dimension that can allow for a wider overall drill press table 20.

As shown in FIG. 7, in some embodiments, the table frame 22 or the table insert 24 can include storage drawers 38 or shelves 40 extending below the top of the table 20. Drawers 38 and shelves 40 can be useful for storing tools, measurement devices, clamps, stops, vises, and/or work elements such as various drill bits, brushes, sanding drums, polishing attachments, etc. In other embodiments, the drawers 38 and/or shelves 40 can be integrated into the table insert 24 such that they do not have to be a permanent aspect of the table frame 22.

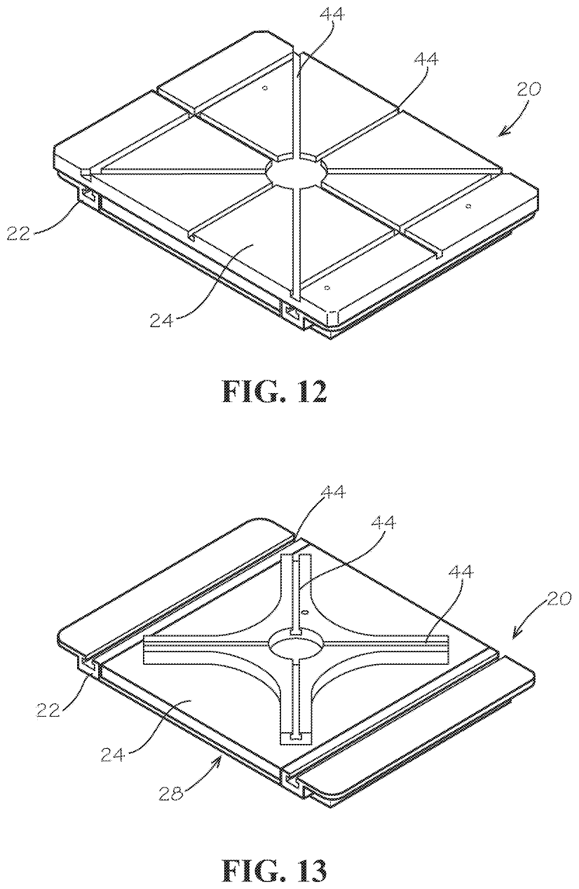

In some embodiments, as shown in FIG. 8, the table frame 22 can include one or more accessory slots 44 that can be formed in lateral sides of the table frame 22. In some embodiments, the slots 44 can have a dovetail shaped cross section, or any other suitable cross section, including but limited to, square, rectangular, or triangular cross sectional slots. The accessory slots 44 can receive adjustable clamps, stops, vises 42, etc. which can be utilized to hold or support work pieces in a desired position or orientation. In other embodiments, as shown in FIGS. 12-14, the table insert 24 can include one or more accessory slots 44 in various configurations and angles to accommodate clamps, stops, etc. in various orientations depending on the needs of theuser. Having accessory slots 44 in the modular table inserts 44 can allow different table inserts 24 to be placed in the table frame 22 depending on the needed or desired clamp, stop, or work piece orientation or position.

In some embodiments, as shown in FIGS. 8-9, the table frame 22 can include several attachment locations 46 that can be used to removably attach a table insert 24 on top of the table frame 22. In some embodiments, the attachment points 46 can also be utilized to attach separate stops, clamps, or wood working tabletops 48 on top of the table frame 22 and table insert 24. Attachment points 46 can be threaded bores or holes that are defined in the table frame 22 such that table inserts, vises, clamps, stops, blocks, or other components can be secured to the attachment points 46 with suitable threaded fasteners.

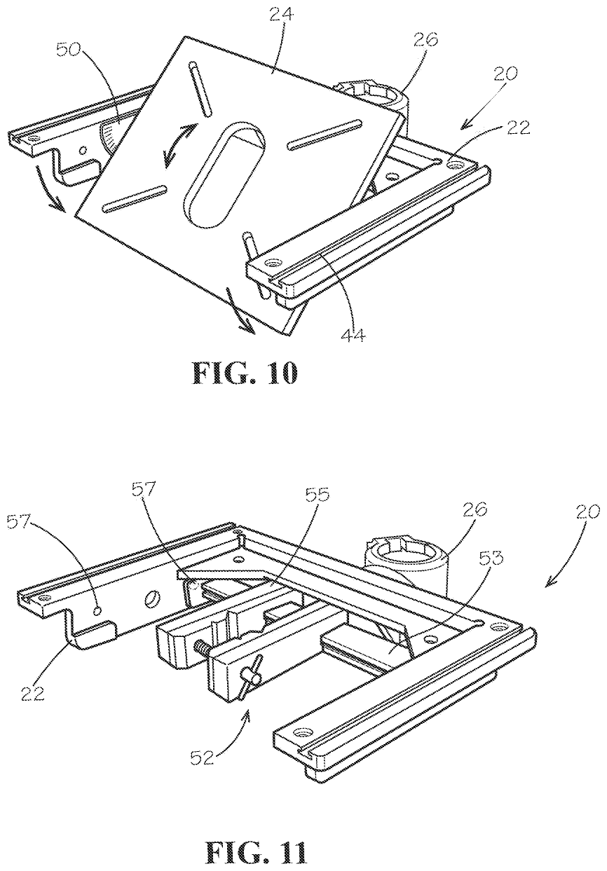

As shown in FIG. 10, in some embodiments, the table insert 24 can be rotatably received in the table frame 22. For instance, in some embodiments, a cross support bar can be rotatably disposed on the table frame 22 and the table insert 24 can be mounted to the rotating cross support. In other embodiments, the table insert 24 can include a laterally extending peg that can be rotatably received in the table frame 22 such that the table insert 24 is rotatable on the table frame 22. A suitable retention mechanism such as a cam lever clamp, set screws, tightening screws, or similar locking mechanism etc. can be utilized to provide a clamping force to selectively retain the cross support or the table insert 24 in a desired angular orientation on the table frame 22. In some embodiments, the table frame 22 can include an angle measurement tool 50 that can be used to measure the angle of the table insert 24 during use. Angling of the table insert 24 can be useful when angled holes are desired in a work piece. The table insert 24 of FIG. 10 shows the table insert 24 being rotatable in a forward and backward direction, with an axis of rotation extending laterally. In other embodiments, the table insert 24 can be rotatably disposed on the table frame in side-to-side or lateral direction and the axis of rotation of the table insert 24 can extend in a forward and backward direction.

In still other embodiments, as shown in FIG. 1, the table frame 22 can include a table frame structure including one or more perimetrical frame members 22a and cross supports 30. The frame structure can be rotatable on the column connection assembly 26 or collar. As such, the table frame 22 can rotate on the collar 26 in a lateral direction or about an axis of rotation extending in a forward and back direction. The column connection assembly 26 can include a measurement device to show the angular orientation of the table frame 22 in relation to a horizontal orientation. A suitable retention mechanism such as a cam lever clamp, set screws, tightening screws, or similar locking mechanism etc. can be utilized to provide a clamping force to selectively retain the table frame 22 in a desired angular orientation on the column connection assembly 26. In some embodiments, the table frame 22 can be rotatable on the connection collar 26 in a lateral direction, and the table insert 24 can be rotatable on the table frame 22 in a forward and backward direction to allow for both a lateral and forward and backward tilt of a work piece positioned or supported on the table insert.

As shown in FIG. 11, in some embodiments, a clamping assembly 52 including a vise rail 53 and a vise 55 mounted on the vise rail 53 can be extended between opposing sides of the table frame 22 in lieu of a table insert. In some embodiments, the vise 55 can be used to clamp a work piece in a desired position beneath the spindle of the drill press. The table frame 22 can include laterally extending holes 57 that can be used to connect fasteners between the vise rail 53 and the table frame 22.

FIGS. 15-18 show a table insert 24 for use with a downdraft or dust collection system 74 during a sanding, grinding, or polishing procedure performed via the drill press 10 wherein the spindle assembly 16 can turn a sanding drum 62 for sanding a work piece 25 on the table insert 24. The table insert 24 can include a down draft table insert portion 80 including a lower dust chute 82, and a top table insert portion 84 positionable above the downdraft table insert portion 80. The top table insert portion 84 including a central aperture 86 for receiving the sanding attachment, and a plurality of dust collection apertures 88 can be disposed about the central aperture 86. Dust and other debris produced from the sanding procedure can be allowed to pass through the dust collection apertures 88 and through the dust chute 82. The dust chute 82 can be coupled to a suction hose 90 of a dust collection system 74 such as vacuum pump system that can produce a suction or downdraft within the table insert 24. The downdraft or suction produced through the table insert 24 can encourage dust produced during a sanding procedure to pass through the dust collection apertures 88, through the dust chute 82, and into the dust collection system 74 to help remove any dust from the drill press table 20. In some embodiments, the plurality of dust collection apertures 88 are positioned above the dust chute 82 when the top table insert portion 84 is positioned over the downdraft table insert portion 80.

In some embodiments, the downdraft table insert portion 80 can include a downdraft plate 83, the dust chute 82 connected to the downdraft plate 83. In other embodiments, the plate 83 and the dust chute 82 can be integrally formed or molded together. The downdraft table insert portion 80 can be inserted into receptacle or recessed area 28 with the dust chute 82 extending through the aperture 32 in the receptacle 28 and the plate 83 can rest on the cross supports 30. In some embodiments, the cross supports 30 can include a recessed internal edge 87 (shown in FIG. 1), adjacent the aperture 32 and the plate 83 can nest in the recessed internal edge 87 to restrict movement of the downdraft plate 83 on the cross supports 30. The top table insert portion 84 can be placed on top of the downdraft table insert portion 80 and can be connected to the table frame 22 via fasteners such as screws or bolts. In some embodiments, the top table insert portion 84 can include a plate 84a and appropriate spacers 84b such that the top table insert plate 84a can be flush with a top surface of the table frame 22 as shown in FIG. 15. The chute 82 can then be coupled to a suction hose 90 from a dust collection system 74 to provide a negative suction pressure through the dust collection apertures 88 in the top table insert portion 84.

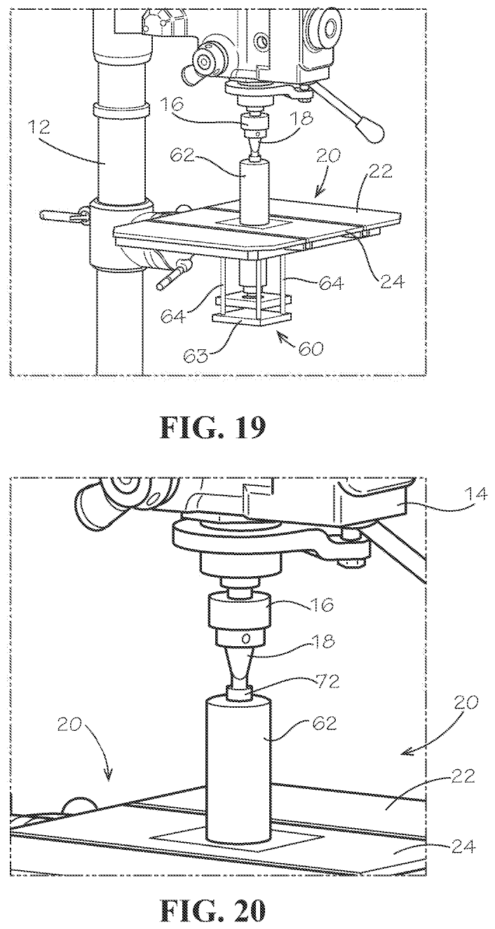

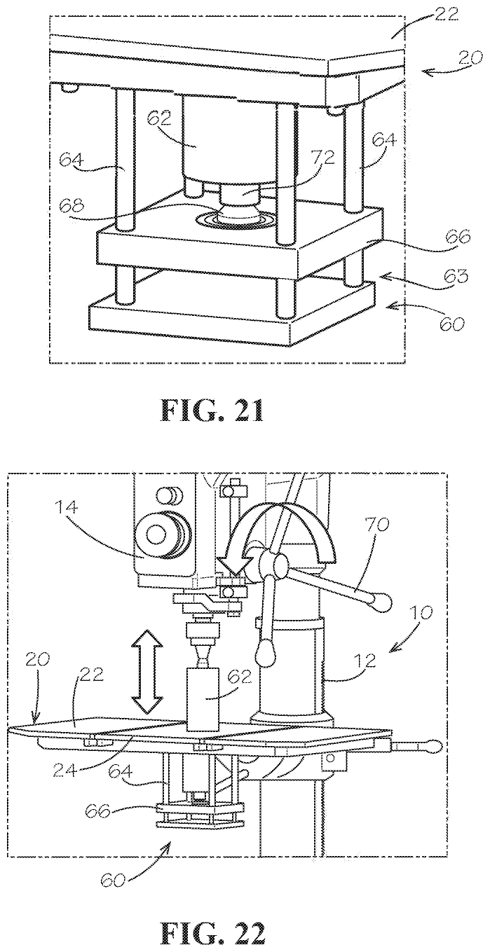

FIGS. 19-23 show a spindle sanding attachment 60 for a drill press table 20. The spindle sanding attachment 60 can be incorporated into a table insert 24 of a modular drill press table 10 in some embodiments. In other embodiments, the spindle sanding attachment can be incorporated into a standard drill press table. A sanding drum 62 of the spindle sanding attachment 60 can be driven by the spindle 16 of the drill press 10 as shown in FIG. 19. The drill press 10 can still perform drilling operations by removing the sanding drum 62 from the spindle 16 and equipping the spindle 16 with a conventional drill bit. One end of a shaft 72 of the sanding drum 62 can be clamped to the chuck 18 of the drill press spindle 16.

An additional sanding drum support 63 can be positioned beneath the drill press table 20 that can receive an opposite end of the shaft 72 of the sanding drum 62 to stabilize the sanding drum 62 during a sanding operation. In some embodiments, as shown in FIG. 17, the sanding drum support 63 can include a plurality of support legs 64 extending down from the drill press table 20 or drill press table insert 24, and a support plate 66 with holes, notches or channels positioned to receive the support legs 64. A sanding drum mounting member 68 can be positioned on the support plate 66. The sanding drum mounting member 68 can receive or engage the shaft 72 of the sanding drum 62 to stabilize the sanding drum 62 via the support legs 64 during a sanding operation and lock the sanding drum 62 in a desired vertical position. In some embodiments, the mounting member 68 can be a simple extension that can be received into the sanding drum shaft 72. In other embodiments, the mounting member 68 can include a central recess for receiving the sanding drum shaft 72. In other embodiments, the mounting member 68 can be configured to threadingly engage a threaded sanding drum shaft 72.

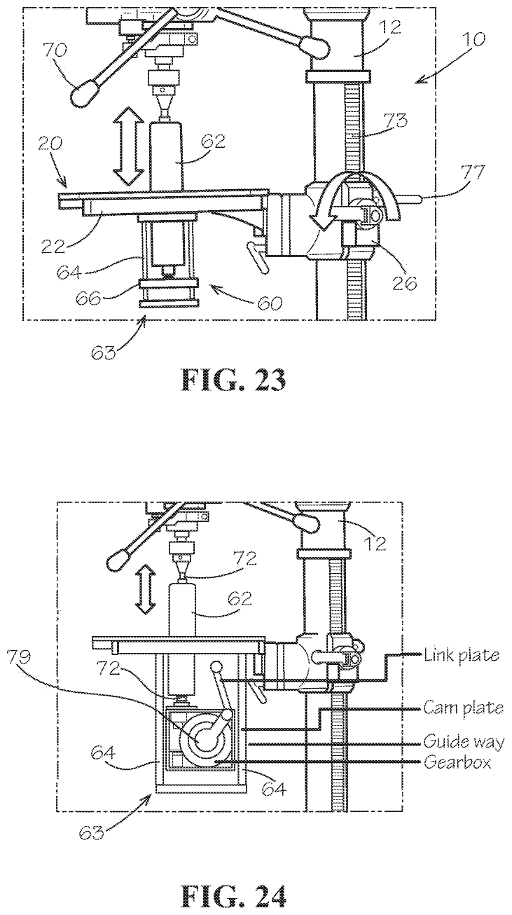

As shown in FIGS. 22 and 23, in some embodiments, the position of the sanding drum 62 and the drill press table 20 or drill press table insert 24 can be adjusted relative to one another to expose more or less of the sanding drum 62 above the drill press table 20 or drill press table insert 24, or generally provide a movement of the sanding drum 62 or the drill press table 20 during a sanding operation to assists in the sanding operation. In some embodiments, the position of the drill press spindle 16 on the drill press spindle assembly 14 can be adjusted via a feeding handle 70 to adjust the position of the sanding drum 62, as shown in FIG. 22, or the position of the drill press table 20 or drill press table frame 22 can be adjusted on the column 12 of the drill press 10, as shown in FIG. 23 by moving a column connection assembly 26 along a linear track 73 on the column 12 by turning handle 77 to move the drill press table 20 via the column connection assembly 26 up and down the linear track 73 via an internal gear system within the column attachment assembly 26. In either case, the support plate 68 and support legs 64 of the sanding drum support 63 can move or slide relative to one another to accommodate movement of either the sanding drum 62 or the drill press table 20.

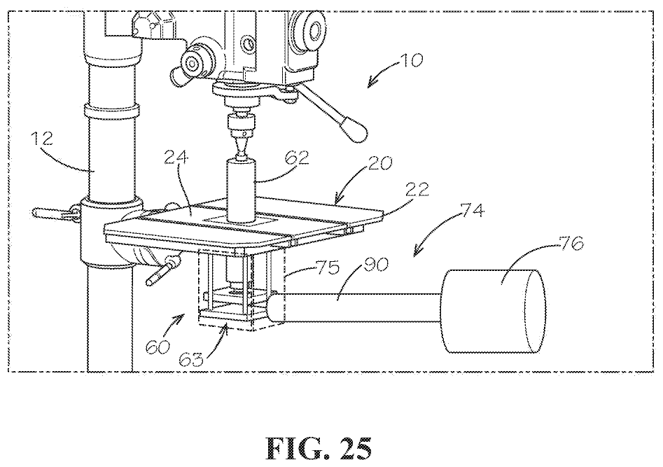

The addition of a dust collection system 74 around the spindle sanding attachment 60 can be included in some embodiments, as shown in FIG. 25. A dust collection bin 75 can be positioned at least partially around the sanding attachment 60 such that the dust collection bin 75 can catch or collect particles and dust falling from the sanding drum 62 during a sanding operation. A vacuum 76 can be connected to the dust collection bin 75 to provide a suction force to draw dust or debris from the dust collection bin 75 for disposal.

The spindle sanding attachment 60 can include sanding drums 62 of varying sizes. Additionally, the sanding drums 62 of FIGS. 15-23 can be replaced with regular brushes and polishing wheels associated with bench grinders can also be included in the sanding attachment for grinding or shaping metals. The adjustment and dust collection features discussed herein can also be utilized for grinding, polishing or other procedures which adjustment and dust collection may be beneficial.

In some embodiments, during a sanding operation, the sanding drum 62 can be oscillated in an up and down direction if desired by manually manipulating the sanding drum 62 via the feeding handle 70 or by adjusting the vertical position of the table 20 on the column 12 as described herein. In other embodiments, as shown in FIG. 24, the sanding attachment 60 can include an oscillator assembly 78 which can include a motor, gear box, eccentric cams, and/or camming arms or linkages which can be driven by a motor to oscillate the position of the sanding drum 62 during a sanding operation such that the oscillation of the sanding drum 62 can be automated. As shown in FIG. 24, the lower end of the shaft 72 on which the sanding drum 62 is disposed can be fixedly secured to a motor assembly 79 positioned on sanding drum support structure 63. The sanding drum 62 can be slidably disposed on an upper end of the shaft 72 connected to the chuck 18. The motor assembly 79 can be connected via arms, linkages or cams to the support structure 63 or to the drill press table 20 such that as the motor assembly 79 rotates, the motor assembly 79 moves in an up and down fashion via the arms, linkages, or cams to oscillate the motor assembly 79 and thus the sanding drum 62 attached thereto.

In some embodiments, the drill press spindle assembly can include a motor assembly that can be operable to selectively alternate the drill press spindle assembly between two or more variable speeds. The drill press spindle assembly can include a spindle gear assembly or transmission that can be operable to selectively alternate the spindle between at least two speeds by alternatingly engaging gears of different sizes that are driven by a motor of the system with the spindle to vary the rotational speed of the spindle. In other embodiments, the motor for driving the spindle can be a bidirectional motor engaged with a two way clutch which can be bypassed when the motor spins in a first direction to drive the spindle at a default speed, but the clutch can be engaged when the motor spins in the reverse direction, the engagement of the clutch engaging a gear system which can either reduce or increase the speed of the spindle.

Combining the modular table of the present disclosure with a variable speed drill press spindle assembly can make a large number of combinations of spindle speeds and table configurations to provide versatility in utilizing the drill press of the present disclosure with various materials and perform various drilling and/or sanding operations on the same drill press.

Thus, although there have been described particular embodiments of the present invention of a new and useful DRILL PRESS WITH MODULAR DRILL PRESS TABLE, it is not intended that such references be construed as limitations upon the scope of this invention.

What is claimed is:

1. A drill press comprising:
a drill press column;
a drill press spindle assembly mounted to the drill press column; and
a drill press table including:
a table frame mounted to the drill press column beneath the drill press spindle assembly; and
a table insert removably received on the drill press table frame.

2. The drill press of claim 1, wherein:
the table frame has a table frame width;
the table insert has a table insert width; and
the table insert width is at least half of the table frame width.

3. The drill press of claim 2, wherein the table insert width is at least 80 percent of the table frame width.

4. The drill press of claim 1, wherein the table frame forms a recessed area shaped to receive at least a portion of the table insert.

5. The drill press of claim 4, wherein the table frame further comprises at least one cross support extending across the recessed area, the cross support supporting the table insert when the table insert is received in the recessed area.

6. The drill press of claim 5, wherein the table insert is removably securable to the at least one cross support.

7. The drill press of claim 6, further comprising a plurality of removable fasteners removably securing the table insert to the table frame.

8. The drill press of claim 1, wherein the table insert has a lower portion and an upper portion, the lower portion received in the table frame, and the upper portion positioned on the table when the lower portion is received in the table frame.

9. The drill press of claim 8, wherein the upper portion extends laterally beyond the table frame when the lower portion is received in the table frame.

10. The drill press of claim 1, wherein the table insert further comprises:
a downdraft table insert portion including a lower dust chute; and
a top table insert plate positionable above the downdraft table, the top table insert portion including a central aperture and a plurality of dust collection apertures disposed about the central orifice.

11. The drill press of claim 10, wherein the plurality of dust collection apertures are positioned above the dust chute when the top table insert portion is positioned over the downdraft table insert portion.

12. The drill press of claim 10, wherein the table insert further comprises spacers positioned between the top table insert portion and the downdraft table insert portion.

13. The drill press of claim 1, wherein the table insert further comprises:
a column connection assembly securable to the drill press column; and
a table frame structure connected to the column connection assembly, the table frame structure selectively rotatable on the column connection assembly.

14. The drill press of claim 1, wherein the table frame includes one or more accessory slots defined in the table frame.

15. The drill press of claim 1, wherein the table insert is rotatably received on the table frame such that the table insert can rotate relative to the table frame.

16. A drill press table for a drill press having a drill press column and a drill press spindle assembly mounted to the drill press column, the drill press table comprising:
a column connection assembly securable to the drill press column;
a table frame connected to the column connection assembly, the table frame positionable beneath the drill press spindle assembly when the column connection assembly is secured to the drill press column, the table frame including a receptacle; and
a table insert, at least a portion of the table insert removably receivable in the receptacle of the table frame.

17. The drill press table of claim 15, wherein:
the table frame has a table frame width;
the table insert has a table insert width; and
the table insert width is at least half of the table frame width.

18. The apparatus of claim 15, wherein when the at least a portion of the table insert is received in the receptacle of the table frame, an upper surface of the table frame and an upper surface of the table insert are in a flush orientation with one another.

19. A drill press table for a drill press having a drill press column and a drill press spindle assembly mounted to the drill press column, the drill press table comprising:
a column connection assembly securable to the drill press column;
a table frame connected to the column connection assembly, the table frame positionable beneath the drill press spindle assembly when the column connection assembly is secured to the drill press column, the table frame including two lateral frame members, at least one cross support extending between the two lateral frame members, and a recessed area formed between the two lateral frame members and above the at least one cross support; and
a table insert, at least a portion of the table insert removably receivable in the recessed area of the drill press table frame.

20. The drill press table of claim 19, wherein the column connection assembly is connected to the at least one cross support member.
